(19) United States
(12) Patent Application Publication
(10) Pub. No.: US 2026/0087555 A1
(43) Pub. Date: Mar. 26, 2026

(54) TOTAL COST OF OWNERSHIP ASSESSMENT METHOD OR SECURITY AT SCALE ASSESSMENT METHOD

(71) Applicant: Kathleen M. Moriarty, Arlington, MA (US)

(72) Inventor: Kathleen M. Moriarty, Arlington, MA (US)

(21) Appl. No.: 19/334,595

(22) Filed: Sep. 19, 2025

Related U.S. Application Data
(60) Provisional application No. 63/697,121, filed on Sep. 20, 2024.

(51) Int. Cl. G06Q 40/06; G06F 21/57; G06Q 10/0635

(52) U.S. Cl. CPC G06Q 40/063; G06F 21/577; G06Q 10/0635; G06F 2221/033

(57) ABSTRACT

A method and system for assessing the total cost of ownership (TCO) of computer software, applications, and hardware with an emphasis on integrated security and risk assessment at scale is provided. The methods and systems address the challenges faced by organizations, especially those with limited resources, in understanding the full costs and responsibilities associated with IT procurement and management, proposing a structured approach to facilitate informed decision-making and vendor comparison.

### RELATED APPLICATIONS

This application claims the benefit of U.S. Provisional Application Ser. No. 63/697,121 filed on Sep. 20, 2024, which application is incorporated by reference in its entirety.

### FIELD OF THE INVENTION

Embodiments of the present invention generally relate to determining a total cost of ownership for computer software, applications, and/or hardware. More particularly, at least some embodiments of the invention relate to systems, hardware, software, computer-readable media, and methods for application and/or risk assessment at scale.

### BACKGROUND

Total cost of ownership and the assessment of IT (Information Technology), which may include security requirements, is individually assessed by customers conventionally. The total cost of ownership, however, is difficult to determine as some costs are difficult to identify and may become apparent only after acquisition. A shared responsibility model, which may describe how security and other duties are divided between a provider and a customer, is the norm. As a result, customers are expected to layer on security controls for many of the services and products acquired or leveraged by their organization. While a few services are beginning to emerge that provide integrated security, there is no easy way for a vendor to convey these advantages in their products and services to their customers.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of an example method for comparing and/or assessing applications;

FIG. 1B discloses additional aspects of comparing and/or assessing applications;

FIG. 2 discloses aspects of insertion points in a computing architecture;

FIG. 3 depicts an example of a cloud native architecture with security services integrated more seamlessly into the architecture; and

FIG. 4 discloses aspects of a computing device, system, or entity.

### DETAILED DESCRIPTION OF SOME EXAMPLE EMBODIMENTS

Embodiments of the invention generally relate to determining a total cost of ownership for computer software, applications, and/or hardware. Embodiments of the invention further relate to facilitating the acquisition of software, applications, and/or hardware that satisfy user requirements and expectations. Embodiments of the invention are discussed, by way of example only, in the context of assessing, at scale, various aspects of an application including application protocol and data flow, security control, and the like or combinations thereof. This assessment may be reflected in an application architecture.

Example embodiments relate to generating an architectural representation of an application that includes data flow, protocol flow, and security control flow representations (e.g., diagrams). This architectural mapping may describe or define data flows, protocol flows, and security controls or flows. The architectural representation can be provided by vendors or derived through audits and may be designed to be consistent and normalized for comparison across products and services.

This architecture may be mapped to standardized (e.g., industry recommended, best practices) risk assessments or architectural representations aligned with established control frameworks. The mapping may identify gaps and align security policies, helping organizations understand potential risks and required or available security controls. Furthermore, embodiments of the invention support defining multiple service levels with varying security provisions and shared responsibility models, allowing customers to select options that best fit their resource capabilities and compliance needs.

### Total Cost of Ownership and Economic Modeling

Example systems and methods may relate to estimating a total cost of ownership. The total cost of ownership may include, by way of example and not limitation, capital expenditures, operational costs, and human resource requirements for both the vendor and the customer. These costs are calculated considering factors such as organization size, user location, application hosting environment (Saas, on-premise), infrastructure type (traditional, virtualized, cloud native), identity and access management needs, supply chain assurance, third party risk, artificial intelligence (AI), AI agents, automation, and additional security infrastructure such as SIEM or web application firewalls. Embodiments of the invention may incorporate crowdsourced data or historical data from existing customers or previous acquisitions to validate resource estimates, enhancing trustworthiness and accuracy.

The modeling may compare/contrast security levels with associated costs, presenting this information clearly to enable business or organization-level decisions. Embodiments of the invention account for built-in security controls versus add-on products, the shared responsibility split between vendor and customer, and variations in service levels targeting different markets. This approach helps prevent costly surprises post-purchase and supports organizations, especially small and medium-sized businesses, in selecting solutions with appropriate security and manageable total costs.

### Security Assurance and Other Features

Embodiments of the invention may provision or enable vendors to supply validation and testing results to demonstrate or highlight the effectiveness of built-in security controls, potentially reducing the need for traditional layered security. This may allow vendor/customer responsibilities to be identified, split, reduced, eliminated, or shared more effectively. Embodiments further relate to ensuring code security, including the use of memory-safe programming languages, secure coding practices, and supply chain traceability to quickly remediate vulnerabilities. Cloud native architectures with continuous integration and delivery pipelines and supply chain assurance automated from the application provider are examples of mechanisms to maintain security posture and reduce dependency on add-on products.

Zero Trust Architecture principles (e.g., isolation, encryption, dynamic authentication/authorization) may be incorporated into the assessment to clarify security control distribution between vendor and customer and to align with cybersecurity standards. The assessment may consider how the controls are implemented.

### Implementation and Validation

The architectural diagrams and risk assessments can be tied to reputation and update services, allowing organizations to crowdsource validation and corrections over time, increasing trustworthiness and keeping information current. Third-party management of these representations or diagrams may enhance reliability. Additionally, data analytics, machine learning, and artificial intelligence may be used to generate and evaluate architectural representations and risk assessments, supporting scalability and consistency.

A risk assessment, in one example, may include the use of risk assessments based on security and control frameworks, software development, supply chain, assurance at runtime, and the like or combinations thereof. The application architecture can be mapped to the risk assessments. This allows a vendor whose products and services are assessed, in one example, to provide applications with built-in security. More specifically, a vendor can improve their products and services and easily convey these improvements/advantages to their customers or potential customers. The customer (or other entity or user) of the assessed vendor may not need to have the infrastructure to provide the security. Stated differently, the risk assessment allows a customer to understand the security or security controls that are built into the vendor's products and services. Advantageously, this understanding may allow a customer to realize that additional infrastructure is not needed and, as a result, the cost can be avoided. A vendor may be able to provide various levels, including shared responsibility levels, that provide a customer with a better understanding or risk assessment and/or cost at each of the various service levels. This may be provided prior to purchase, at the time of purchase, or later. Results from assessments may be updated with subsequent assessments.

Generally, an application may be associated with a total cost of ownership that typically includes capital expenses and operational expenses. Embodiments of the invention help customers avoid situations where costs may be higher after acquisition by accounting for other costs, which may relate to security requirements or other aspects of operating or using a product or service.

Risk assessments for the security and compliance of a service or product may be assessed through review of audit reports (e.g., ISO/IEC 27001, SOC2) provided by the vendor or service provider. Additionally, organizations can review information aligned to the Cloud Security Alliance (CSA)'s Cloud Controls Matrix (CCM) in the self-reported Cloud Security Alliance (CSA) Security, Trust, Assurance, and Risk (STAR) program. These are helpful resources that enable an user to determine if the security levels offered in a product match the requirements of the acquiring organization's security and compliance policies.

Mapping the security levels offered in a product to the security and compliance policies of an organization by hand is difficult to accomplish at least because an understanding of the policy requirements and how each policy requirement can be adequately met is required. This also requires an understanding of the control capabilities that the organization may deploy or enable in order to fulfill a shared responsibility model.

Embodiments of the invention advantageously reduce costs IT management (e.g., application acquisition and deployment), which have largely been a burden distributed to the purchaser of an application. Additionally, embodiments of the invention provide a consistent methodology for assessment and comparison that provides an upfront assessment of the total cost of ownership with an improved understanding of the level of security being provided.

Small and medium business, local governments, and other organizations or users that have limited resources may be targeted by ransomware attacks at a significantly higher percentage than organizations with mature and well-developed security programs. Threat analyst firms in 2024 suggest that about 85% of ransomware attacks target small and medium-sized businesses. This pattern continues, in part, due to the expectations placed upon small organizations to manage security following the same patterns of well-resourced organizations who require transparency for audit purposes and full configurability. Embodiments of the invention note the organizations are too far apart when it comes to security controls and there can be levels created for alignment and consistency to reduce this demand on full configurability for organizations that have fewer resources to manage IT and security.

Organizations typically follow a business application procurement process, where the business specifically examines the application's features and core costs to determine its product selection. IT and security teams then determine the requirements to run the selected application within the organization's policy and regulatory requirements. While this method separates out capital expenditures from operating expenses, it often leads to higher overall costs and unsustainable solutions that require high levels of resources for ongoing management. Embodiments of the invention, in contrast, can determine a more accurate or improved estimate of the total cost of ownership or total cost of use.

A method to streamline and consistently compare applications is disclosed, providing a novel assessment methodology better suited to organizations with few resources and aligned with industry direction, promoting built-in security by design and by default models. This methodology further considers the scaling aspects necessary to better serve small and medium sized organizations as well as better position vendors to serve this market.

Embodiments of the invention relate to aligning at least security and compliance requirements. This may advantageously enable solutions that better serve the requirements of organizations with fewer resources.

In one example embodiment, an architectural representation (e.g., a diagram) of the application is determined. The architectural diagram may be formalized (and/or normalized) to document the flow of data and protocols. All protections may be documented or represented. The architectural diagram of an application (or product or service) may be provided either by the vendor or by an audit of the vendor or the vendor's applications where the security controls, protocols, and data flows of the applications are examined. In one example, the format is consistent and aligned for ease of comparison and interpretation by organizations of all sizes. Optionally, the diagrams and accompanying data are tied into a reputation and update service to allow organizations with resources to both validate the provided data and correct any findings over time. The vendor may also update the architectural diagram over time to reflect changes or improvements in their service offerings. The architectural diagrams may be managed by a third party to aid in the trustworthiness of the crowd-sourced validation process.

Resource requirements are calculated and offered to provide a realistic expectation for the implementing customer that may be based on a number of factors. These factors include, but are not limited to, the size of the organization, the location of users (e.g. remote, on-premise, international with varying regulatory requirements), the location of the application (e.g. hosted on a SaaS platform, hosted on premise), the infrastructure supporting the application (e.g. traditional architectures involving defense-in-depth controls, virtualized environments, and cloud native architectures with seamless zero trust controls, and everything in-between), the identity and access management requirements, any associated requirements for managing client agents, or credentials, and security infrastructure requirements (e.g. security incident and event management, SOAR, posture assessment, CNAPP platforms, data leakage protection, threat intelligence feeds and integration, web application firewalls, etc.).

The resource calculations may be validated from existing customers (e.g., historical data), crowd-sourced data, or the like, improving the trustworthiness of the listed assessments. The comparisons may be centrally hosted, ideally in a consistent or standardized format.

The comparisons may be updated over time as vendors seek to better meet the needs of organizations with few resources.

The economic modeling may consider the vendor, customer, and/or the combination at each service level offered, providing a unique and compelling driver for the selection of service and product offerings as well as to drive security cost and efficiency improvements.

The vendor may also supply testing-to-demonstration validation of built-in controls that effectively reduce or eliminate the need for traditional security and IT management layers. Updated methods to built-in security may reduce or remove the need for traditional infrastructure. For instance, intrusion prevention may no longer be necessary when data is fully encrypted and vulnerabilities in the code base have been effectively reduced (e.g., memory safety).

The assessed security level may be mapped to include how controls are met, and this may aid in the economic modeling provided.

Assurance of code security may be provided to demonstrate a reduction in vulnerabilities, such as memory execution safety provided as built-in through the use of memory-safe programming languages, architectures for coding that offer protection of memory when interfacing with existing libraries programmed using interfaces that are non-memory safe, and/or integration of code scanning or secure code validation in the development process.

Assurance of the supply chain with full knowledge of the code base providing traceability to allow for quick remediation of vulnerabilities as part of the development lifecycle may be provided.

Levels of service options may be noted for vendors accommodating multiple markets where the security and IT management provided and expected of the customer can vary based on the shared responsibility model for that level. An organization with few resources may favor security provided as part of the product or service, and those well-resourced may prefer to control management and policy expectations with a shared responsibility model.

The full expectations of controls to reach the audit level provided in a risk assessment and architectural protocol and data flow diagram may be detailed to understand cost estimates as a layer of the supporting analysis, for both the vendor and customer.

How controls are provided may vary based on the foundational infrastructure model (e.g. traditional, virtualized, or cloud native) and whether those controls are integrated into the platform or added on with layered security products. Integration may remove the need for some controls used in traditional architectures, where the property of the control can be provided seamlessly and at a different cost point.

Understanding how security controls are provided and who is responsible for managing them up-front before an application is purchased can help organizations with the selection of a product. This can also prevent the customer from selecting a product that ultimately does not meet their needs, where they have to back away partway into an implementation due to a misunderstanding of the total cost of ownership. In one example, this method assists organizations and vendors to meet the needs of varying markets with visible comparisons on built-in security that critically considers scale from the viewpoint of the customer's implementation. Organizations with few resources will likely favor applications that built-in security at scale, limiting the need for configuration requirements distributed to the customer. This is currently not available for comparison and novel to help meet the needs of the business market.

Embodiments of the invention reduce the need for distributed experts at every organization in security by leveling up the security and IT-related information. This method enables a business level decision during product or service acquisition allowing organizations to focus on product selections based on business needs. Embodiments of the invention allows for comparisons between offerings that provide a consistent view for: comparing security controls and risk assessments, application integration to understand how the new application impacts your overall network security posture (e.g. opportunities for lateral movement, data exposure) from the application protocol and data flow diagrams, total cost of ownership considering infrastructure and human resource requirements, and crowd sourcing validation from well-resourced consumer organizations or consumers.

While there are many resources available today and vendors often have audit reports to provide, customers without deep security experience are unable to fully understand the content and draw comparisons without hiring experts. Businesses with few resources often are not able to afford that expense. In one example, the embodiments of the invention allow for a service to simplify product selection, to drive improvements in delivering services to meet the needs of this market, and to improve security delivered as built-in with reduced costs to meet the market needs. This method can be offered in parts or whole as a service for many business applications, providing expertise on the assessment aspects enabling change to the procurement process with this method of determining total cost of ownership.

A example method to streamline and consistently compare applications is disclosed, providing a novel assessment method promoting built-in security by design and by default models. Embodiments of the invention may further include scaling aspects necessary to better serve organizations of varying sizes and resource levels. The modeling encompasses costs and security controls for both the providing vendor product or service and the customer.

Embodiments of the invention involve several areas for alignment that can be distinct or combined. For example, data flows, protocol flows, compliance, and/or security flows can be aligned independently or separately.

An architectural diagram of the application is generated to document the flow of data and protocols with all protections documented and identified. The architectural diagram is provided either by the vendor or by a third party audit or assessment of the vendor where the security controls, protocols, and data flows are examined.

Optionally, the architectural diagrams and accompanying data may be tied into a reputation service allowing for organizations to increase or decrease the trustworthiness of the provided architectural diagrams.

An update service to allow for organizations to both validate the provided data (e.g., architectural diagrams) and correct any findings over time may also be integrated. The vendor may also update the architectural diagram over time to reflect changes or improvements in their service offerings.

Risk assessments are provided in a consistent format, aligned to a control framework (e.g. ISO/IEC 27001, NIST Special Publication 800-53, NIST Cybersecurity Framework (CSF2.0)). The risk assessments may be prioritized based on the known current threats with alignment to industry de facto standards such as the MITRE ATT&CK framework and the Center for Internet Security (CIS) Critical Security Controls for prioritization (or any other defect standard that emerges).

Embodiments of the invention may reference existing aggregated supporting data including open and proprietary sources. Embodiments of the invention may utilize vendor provided audit report results. Embodiments of the invention may include known remaining gaps from vulnerabilities that may be noted at time of publication or at a point later in time when identified.

Vendors may provide multiple levels of service targeting different markets, where the level of security provided versus a shared responsibly level varies. This aspect provides a point of differentiation for specific markets, whether that be adherence to a particular regulation in one level, a varying degree of configurability, or other variations on the shared responsibility model.

Cultural norms and regional or national cybersecurity strategies may be factored into the risk assessment for the vendor, locations where development or hosting occurs, and for the customer expectations.

Resource requirements are calculated and offered to provide a realistic expectation for the implementing customer that may be based on a number of factors. These factors include, but are not limited to, the size of the organization, the location of users (e.g. remote, on-premise, international with varying regulatory requirements), the location of the application (e.g. hosted on a SaaS platform, hosted on premise), the infrastructure supporting the application (e.g. traditional architectures involving defense-in-depth controls, virtualized environments, and cloud native architectures with seamless zero trust controls, and everything in-between), the identity and access management requirements, any associated requirements for managing client agents, or credentials, and security infrastructure requirements (e.g. security incident and event management, SOAR, posture assessment, CNAPP platforms, data leakage protection, threat intelligence feeds and integration, web application firewalls, AI, AI agent interfaces, etc.).

The resource calculations may be validated from existing customers (crowd-sourcing), improving the trustworthiness of the listed assessments.

The comparisons may be centrally hosted, ideally in a consistent or standard format to ease the burden on organizations with few resources.

The comparisons may be updated over time as vendors seek to better meet the needs of organizations with varying resource levels and requirements.

The economic modeling may consider the vendor, customer, and/or the combination at each service level offered.

The vendor may provide supply chain or posture/integrity assessment testing results to demonstrate validation of built-in controls that effectively reduce or eliminate the need for traditional security and IT management layers.

The assessed security level may be mapped to include how controls are met. Assurance of code security may be provided to demonstrate a reduction in vulnerabilities. Assurance of the software supply chain may be provided.

A cloud native architecture that enables a continuous integration and continuous delivery of updates to resolve identified issues may also reduce the need for add-on products and may be noted.

Integration of assurance of running code through one or more means could be accounted for in the total cost of ownership economic modeling.

Embodiments of the invention may relate to or provide zero trust architectural tenets such as isolation, encryption (and key management), dynamic authentication and authorization will be understood to aid in the breakdown of the distribution of controls between the vendor and customer.

Associated costs including human resource requirements considering contributing factors such as size of the customer or number of users may be factored into the method.

If the product requires add-on services and additional products to meet the stated security level, those may be included to assure the total cost of ownership modeling fully encompasses these additional tools, required management, and other costs to the vendor and/or the customer.

Expected total cost of ownership is provided considering the business application and functionality selected, architectural requirements of the vendor and the customer, the level of security and compliance required, and the resource requirements for initial installation and ongoing management.

Total cost of ownership may be contrasted with the security level, calculated in detail and presented at a high level to enable business decisions.

Inclusion of security properties such as a Zero Trust Architecture, NIST SP 800-207, may be included to ensure an understanding of the level of protection and the maturity of the program will be well understood.

The level of controls for the security program and if they are built-in or added on with additional products will be considered along with the costs for both the providing vendor and customer, with divisions noted to accommodate for vendors using a shared responsibility model.

Levels of service options may be noted for vendors accommodating multiple markets where the security and IT management provided and expected of the customer can vary based on the shared responsibility model for that level.

The full expectations of controls to reach the audit level provided in a risk assessment and architectural protocol and data flow diagram may be detailed to understand cost estimates as a layer of the supporting analysis, for both the vendor and customer.

How controls are provided may vary based on the foundational infrastructure model (e.g. traditional, virtualized, or cloud native) and whether those controls are integrated into the platform or added on with layered security products. Integration may remove the need for some controls used in traditional architectures, where the property of the control can be provided seamlessly and at a differing cost point.

In support of the economic modeling, the costs may be broken out for the vendor and customer as capital expenditures and operating expenditures, including human resource estimates. Human resource estimates may be provided in terms of the number or percentage of full time employees required to manage the solution plus expected security controls and any applicable add-on products to reach to the stated security assurance level. This may be done to accommodate cost variations on resourcing depending on location and expertise levels that can impact cost models. Total cost of ownership is typically not understood at time of purchase and can have a substantial impact on the security of a business application and the data protection level for the customer.

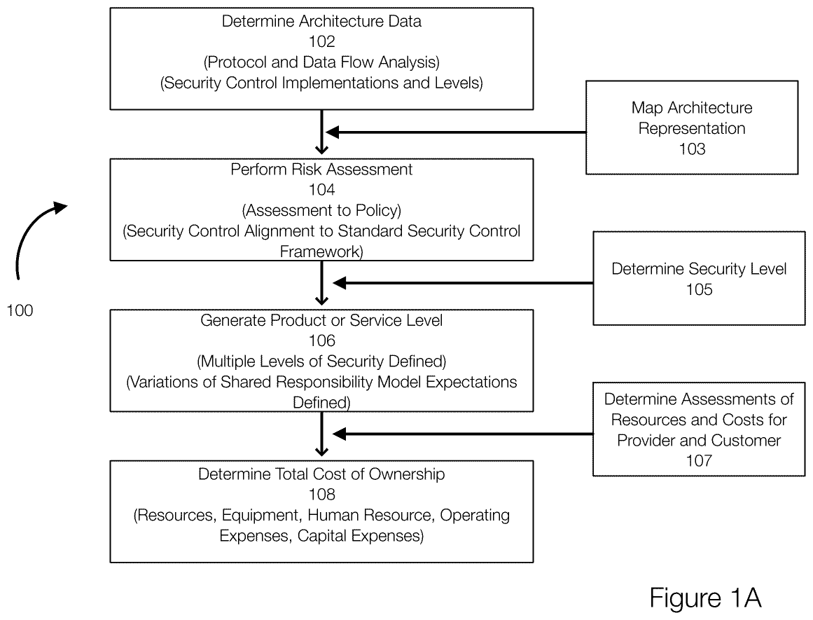

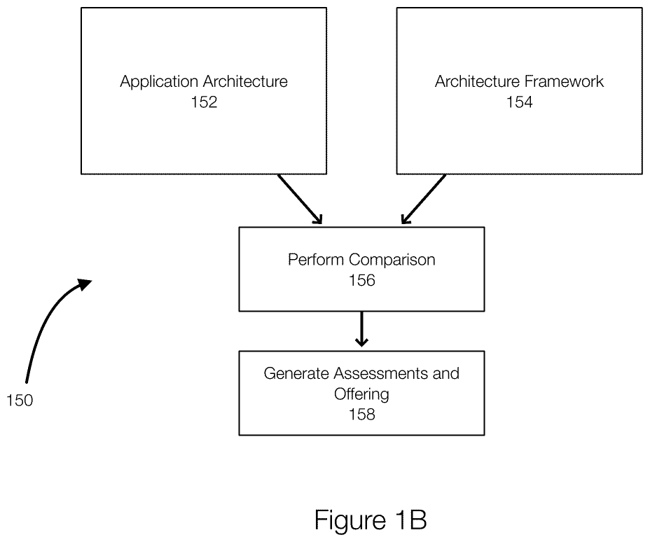

FIG. 1A discloses aspects of an example method for comparing and/or assessing applications. The method 100 may allow an organization or other entity to have a better understanding of the total cost of ownership, enable a service level to be evaluated or selected, determine levels of shared responsibility, generate or identify vendor and organization responsibilities, and the like. The elements the method 100 may be performed collectively. However, each element may also be an independent method.

The method 100 includes determining 102 an architecture of an application. Determining 102 the architecture may include performing a protocol analysis, a data flow analysis, and/or a security control analysis. The protocol, data flow, and security control may be represented in the application architecture. This may result in an architectural representation (e.g., a diagram) that can be compared to other architectural representations.

A protocol analysis may relate to traffic, packet format, and pattern identification (authentication, encryption, error handling). The protocol analysis may determine how an application reacts to errors, and the like.

A data flow analysis may relate to how data moves within an application, in a network, or the like. A data flow analysis may relate to how sensitive data is stored and processed, how privacy and security policies are enforced, and the like. In one example, data flow analysis may relate to the flow of data inside an application, and protocol analysis may relate to how the application communicates outside of the application.

A security control analysis may relate to identifying and/or evaluating security controls within an application or a computing system. For example, a security control analysis may identify gaps in security, verify the existence of certain controls, compare existing controls against standards, and the like. Security control is configured to protect the application.

In the context of a customer evaluating applications, the application architecture allows the customer to examine and compare applications in terms of, by way of example and not limitation, protocol, data flow, application programming interfaces (APIs), and security control. This may also allow a customer to compare the architecture representation to a standardized or recommended architecture. For example, an application architecture may indicate that the application includes an authentication control based only on username and password. Comparing to a recommended architecture may identify a more secure authentication control that includes multi-factor authentication or single sign-on authentication.

The vendor may offer multi-factor authentication at a different service level. By providing this as an option, a user may not be required to incur costs with implementing multi-factor authentication on their own because it is included in the vendor's offering. At the same time, this comparison may highlight a potential security issue that allows the purchaser to make a decision about the desired authentication security control.

Risk assessments allow architectural diagrams to be compared between applications (e.g., two different products or services), between an application and a best practices representation, or the like. The risk assessment may also provide a user with a better understanding of what is included and what is not included in an application being considered for purchase or use.

In this example, determining the architecture of an application 102 may also relate to implementations and levels. This may allow a customer to select varying levels based on customer requirements.

The method 100 further includes determining 104 risk assessments. The risk assessments may conform to a control framework (e.g., a control architecture) and may relate to policy assessments. This allows security controls (or protocol and data flows) to be aligned (or compared) to a standard security (data or protocol) control framework. This provides a user, such as a customer, with information regarding potential risk. The method may further include mapping 103 the architecture of the application.

The risk assessment 104 may include mapping 103 the architecture of the application 103, in terms of protocol, data, and security, to a standard control framework. The risk assessment 104 may perform an assessment related to policy. The risk assessment 104 allows gaps to be identified in the application. This also allows a customer to be aware of potential costs that may be required (e.g., at least in terms of security) to achieve a particular level of security or to achieve desired data/protocol flows. Performing the risk assessment 104 may enable a vendor or customer to align security controls with standard security controls if desired.

The method 100 may include a security level determination 105 operation to determine product or service levels 106. The product or service levels may define multiple levels of security and present a variety of a shared responsibility models. This allows a customer to be aware of built-in security, select a particular service level, or be aware of services not included in a product. Using the previous example, one service level may include basic authentication while another service level may include multi-factor authentication. If multi-factor authentication is not part of the vendor's offerings, this may be presented as a shared responsibility option where basic authentication may be provided by the vendor, but additional authentication capability is the responsibility of the customer.

The method 100 may also provide or determine assessments 107 of resources and costs for the provider and the customer. This allows the customer to be aware of all or most costs, including operational. capital costs, human resource costs and/or other costs. Some of costs may be derived or estimated from previous purchases or other sources including historical data and crowd-sourced data.

More specifically, the total cost of ownership 108 is determined or estimated. Embodiments of the invention may learn, based on previous experiences or product acquisitions, of costs that may be included in acquiring a particular product. For example, a human resource cost may be difficult to determine for an application. As different service levels are presented, the total cost of ownership or use may be different for the various levels. In addition, selecting a service level, which may include shared responsibility aspects, provides the estimated costs to both the vendor and the customer. The costs may be reflected monetarily, but also in terms of time, employees, infrastructure, and the like.

The method 100 may allow security levels to be determined and provide an assessment of costs to both the customer and the provider that is more accurate than conventional methods.

FIG. 1B Illustrates an example of performing a risk assessment to determine or estimate a total cost of ownership. The method 150 may include generating an application architecture 152. A vendor may have architectures generated in advance. An architecture framework 154 (an example of an architecture used for comparison) may also be available to the method 150. The framework 154 may be another application from another vendor, a standard or best practice framework, an industry-generated framework, or the like.

In this example, the architectures 152 and 154 are formatted or organized for comparison. The comparison is performed 156. This allows differences (e.g., gaps, deficiencies, excesses) or the like to be determined. The assessments and offerings may be generated 158. For instance, a vendor may offer service levels with different types of authentication or encryption. The vendor may offer service levels with different types of data storage. The assessment allows a customer to understand the security, protocol, and/or data flows for each service level and allows the customer to understand their own responsibilities based on the selected service level. A total cost may be determined based on the selected service level. Certain costs, such as exposure to malware (e.g., when selecting a basic authentication) may also be inherently understood by the customer and the vendor.

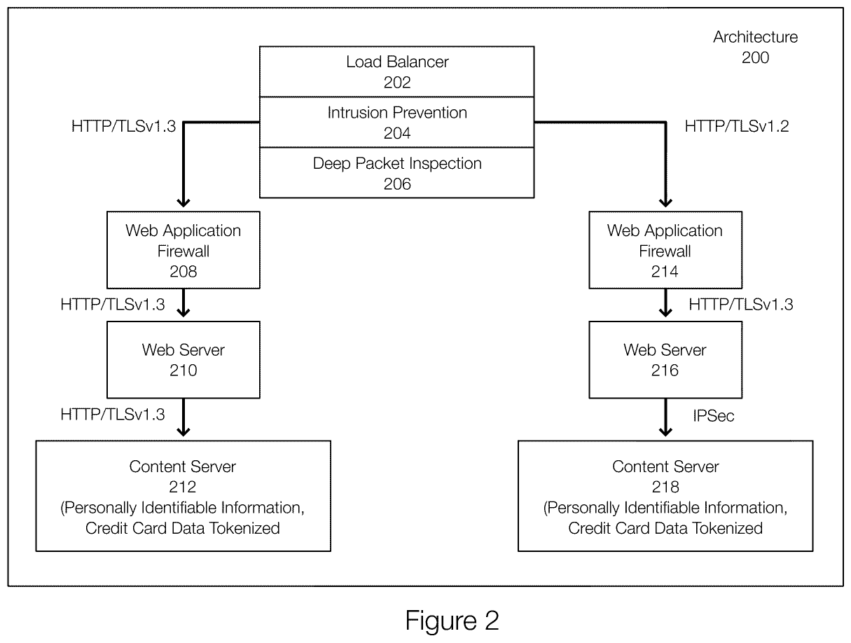

FIG. 2 depicts a network architecture with possible insertion points, by way of example and not limitation, that may be included for add-on security services. These example insertion points and/or add-ons may include a web application firewall 208, intrusion prevention systems 204, deep packet inspection 206, protection of data through transport encryption, and the like. More specifically, the architecture 200 may illustrate that the offering may include a load balancer 202, intrusion prevention 204 and deep packet inspection 206. The content server 212 may be associated with a particular protocol (e.g., HTTP/TLSv1.3) while the content server 218 is associated with a different protocol (IPSec). These are examples of included security or add-on security. The architecture illustrates data flow and architecture flows to different content servers.

One flow relates to the web application firewall 208, the web server 210, and the content server 211 while another flow relates to the web application firewall 214, the web server 216, and the content server 218. Additional services may include, but are not limited to, encryption at rest, key management, identity and access management, supply chain assurance, code security, incident and event management products, disaster recovery, and the like. These additional services may be represented in architectural diagrams. Multiple base architectures are possible for protocol and data flow architectural diagrams from traditional infrastructure, to virtualized infrastructure, to cloud native platforms and beyond. The maturity of a service may vary and will be understood by the level of protection as well as the integration of services as intrinsic/built-in or as add-on. The architecture 200 can be compared to another architecture to identify differences, generate recommendations, determine service levels, and the like.

For example, these security aspects of the network may be included in the architecture diagram of an application and identified as security controls. The data flow with respect to security controls and other protocols may be reflected in the architectural mapping. This may also allow the security associated with one application to be compared to the security of another application. Embodiments of the invention may further reflect these distinctions in the estimated total cost.

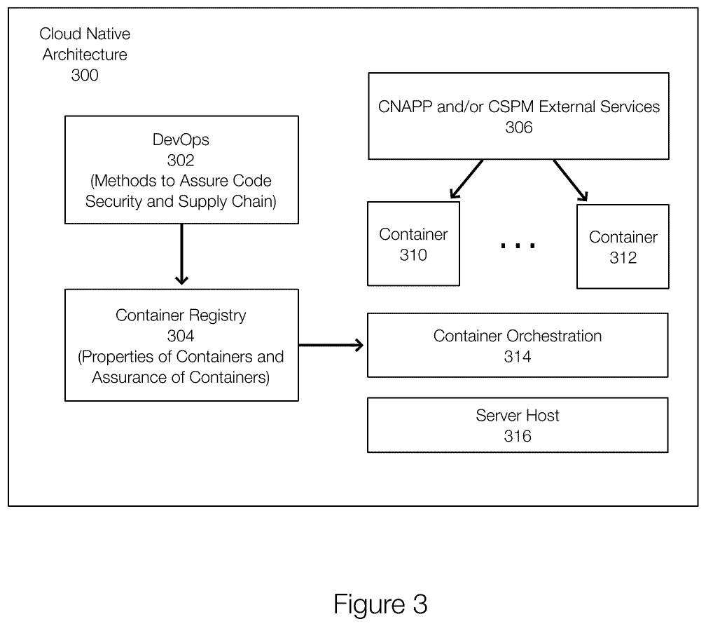

FIG. 3 depicts an example of a cloud native architecture with security services integrated more seamlessly into the architecture, representing one possibility for a more mature security program with the potential to replicate security controls across hosting instances for a full client base at one or more defined security levels. The architecture 300 illustrates DevOps 302 and a container registry 304. This allows integration points for security in the continuous delivery and continuous integration software development pipeline to provide an assurance of code and supply chain security levels. This security impacts the orchestration 314, which May operate on a server host 316. Posture assessment, intrusion detection, filtering, incident and event management, and other services may be depicted to represent the full set of services offered by a platform, product, or service. The containers 310 and 312 represent instantiated containers that may receive security or other services from external services 306 by way of example only.

In another example embodiment, the architectural diagram, risk analysis, cost estimate, and the like may be generated, at least in part, using data analytics, machine learning and/or artificial intelligence. Models may be trained to generate architecture diagrams of an application. The protocols, data flows, and security controls of applications can be evaluated using data analytics, used to train models, and the like. The economic modeling and any part of the assessment may be automated and may leverage AI or AI agents. A return on investment may be provided to the vendor (organization being assessed through this process).

The following examples illustrate examples of risk assessment.

Example 1: In one example, systems and/or methods are disclosed where architectural diagrams (e.g., data, protocol, and/or security) are formalized or generated. Thus, the flow of data, data types, and protocols with all protections are documented or included in the architectural representation. In one example, characteristics and associated requirements for protecting data may be determined by a policy mapping, which is maintained separately from globally applicable architectural diagrams. More specifically, policy and regulatory requirements may vary across regions, industries, and organizations. Thus, the policy mapping may be maintained separately.

The diagrams and accompanying data may be tied into a reputation service, which may allow organizations to increase or decrease the trustworthiness of architectural diagrams. An update service may allow an organization, a service, or a vendor to validate a diagram and make corrections. The diagrams may also be managed by a third party.

Example 2. Systems and/or methods are provided or disclosed for providing risk assessments in a consistent format and aligned to a control framework. The risk assessments may be prioritized based on the known current threats with alignment to industry de facto standards. In one example, existing aggregated supporting data including open and proprietary sources may be referenced. Vendor generated audit reports may be used. Gaps from known vulnerabilities that may be identified may be included. Multiple levels of service targeting different markets may be represented for any given product or service or method, where the level of security provided varies or a shared responsibility level of service varies. This aspect provides a point of differentiation for specific markets, whether that be adherence to a particular regulation in one level, a varying degree of configurability, or other variations on the shared responsibility model.

Cultural norms and regional or national cybersecurity strategies may be factored into the risk assessment for the vendor within the described method, locations where development or hosting occurs, and for the customer expectations. This adds an element not typically accounted for today.

Example 3. Systems and methods are disclosed that may include a calculation on resource requirements. Resource requirements are calculated and offered to provide a realistic expectation for the implementing customer on costs that may be based on a number of factors. These factors include, but are not limited to, the size of the organization, the location of users (e.g. remote, on-premise, international with varying regulatory requirements), the location of the application (e.g. hosted on a SaaS platform, hosted on premise), the infrastructure supporting the application (e.g. traditional architectures involving defense-in-depth controls, virtualized environments, and cloud native architectures with seamless zero trust controls, and everything in-between), the identity and access management requirements, any associated requirements for managing client agents, or credentials, and security infrastructure requirements (e.g. security incident and event management, SOAR, posture assessment, CNAPP platforms, data leakage protection, threat intelligence feeds and integration, web application firewalls, etc.). The resource calculations may be validated from existing customers (crowd-sourcing), improving the trustworthiness of the listed assessments. The comparisons may be centrally hosted, ideally in a consistent or standard format to ease the burden on organizations with few resources. The comparisons may be updated over time as vendors seek to better meet the needs of organizations with varying resource levels and requirements. The economic modeling may consider the vendor, customer, and/or the combination at each service level offered. The modeling of costs is based on the cited service level and control levels in the service or product risk assessment and architecture diagrams to aid in expectation setting for an end customer and to level out the comparisons between similar products.

Example 4. Systems and methods are disclosed for allowing vendors to supply testing results to demonstrate validation of built-in controls that effectively reduce or eliminate the need for traditional security and IT management layers. The assessed security level may be mapped to include how controls are met. Assurance of code security may be provided to demonstrate a reduction in vulnerabilities. Associated costs including human resource requirements, considering contributing factors such as size of the customer or number of users, may be factored into the method.

Example 5. Systems and methods are disclosed for providing an expected total cost of ownership considering the business application, functionality selected, architectural requirements of the vendor and the customer, the level of security and compliance required, and the resource requirements for initial installation and ongoing management. The total cost of ownership may be contrasted with the security level, calculated in detail and presented at a high level to enable business decisions between comparable products. Security properties such as a Zero Trust Architecture, NIST SP 800-207, may be included to ensure an understanding of the level of protection and the maturity of the program. The level of controls for the security program and if they are built-in or added on with additional products will be considered along with the costs for both the providing vendor and customer, with divisions noted to accommodate for vendors using a shared responsibility model. Levels of service options may be noted for vendors accommodating multiple markets where the security and IT management provided and expected of the customer can vary based on the shared responsibility model for that level. The full expectations of controls to reach the audit level provided in a risk assessment and architectural protocol and data flow diagram may be detailed to understand cost estimates as a layer of the supporting analysis, for both the vendor and customer in this total cost of ownership assessment method. How controls are provided may vary based on the foundational infrastructure model (e.g. traditional, virtualized, or cloud native) and whether those controls are integrated into the platform or added on with layered security products. Integration may remove the need for some controls used in traditional architectures where the property of the control can be provided seamlessly and at a differing cost point. In support of the economic modeling, the costs may be broken out for the vendor and customer as capital expenditures and operating expenditures, including human resource estimates. Human resource estimates may be provided in terms of the number or percentage of full time employees required to manage the solution plus expected security controls and any applicable add-on products to reach to the stated security assurance level. This may be done to accommodate cost variations on resourcing depending on location and expertise levels that can impact cost models. Total cost of ownership is typically not understood at time of purchase and can have a substantial impact on the security of a business application and the data protection level for the customer.

Example 6. Systems and methods are provided for processing on the acquisition, generation, evaluation, or comparison of data or data sets. This may include analytics, machine learning, or artificial intelligence.

Example 7. The systems and/or methods of examples 1, 2, 3, 4, 5, and/or 6, and or combinations thereof.

The embodiments disclosed herein may include the use of a special-purpose or general-purpose computer, including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general-purpose or special-purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, engine, agent, service, or the like may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

Any one or more of the entities disclosed, or implied, by the figure and/or elsewhere herein, may take the form of, or include, or be implemented on, or hosted by, a physical computing device. As well, where any of the aforementioned elements comprise or consist of a virtual machine (VM), that VM may constitute a virtualization of any combination of the physical components disclosed herein. Any of the aforementioned elements may comprise or consist of virtualized containers on a server host or containers as part of a cloud native architecture.

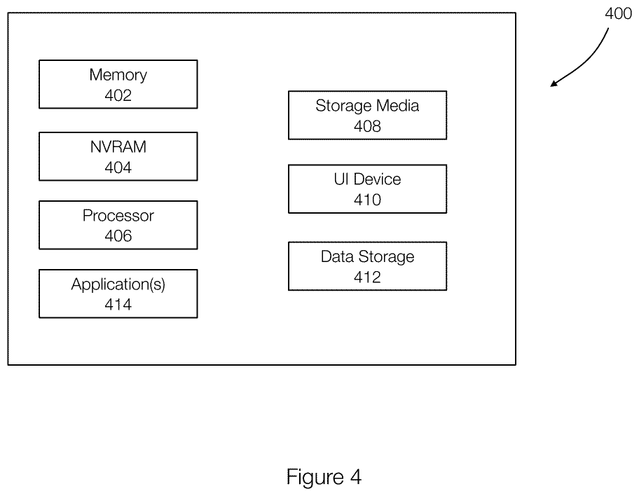

With reference to FIG. 4, one or more of the entities or systems disclosed, or implied, by the Figures and/or elsewhere herein, may take the form of, or include, or be implemented on, or hosted by, a physical computing device, one example of which is denoted at 400 in FIG. 4. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
generating an architectural representation of an application;
generating a mapping of the architectural representation of the application to a risk assessment;
selecting a service level based on the mapping; and
presenting a total cost of ownership based on the selected service level.

2. The method of claim 1, wherein the architectural representation includes a data flow architecture, a protocol flow architecture, and a security control flow architecture.

3. The method of claim 1, wherein the mapping aligns security policies to a standardized architecture.

4. The method of claim 1, further comprising defining multiple levels of security, wherein the selected service level includes some of the levels of security.

5. The method of claim 4, further comprising defining the multiple levels of security.

6. The method of claim 4, further comprising presenting multiple shared responsibility models.

7. The method of claim 1, wherein the selected service level defines expectations for a customer and a vendor of the application.

8. The method of claim 1, wherein the total cost of ownership includes a cost of operations and a cost of hardware and a capital cost.

9. The method of claim 8, wherein the total cost of ownership includes a human resources cost and an operating cost.

10. The method of claim 8, wherein at least a portion of the total cost is based on previous experience, which includes crowdsourced data.

11. A non-transitory storage medium having stored therein instructions that are executable by one or more hardware processors to perform operations, the operations comprising:
generating an architectural representation of an application;
generating a mapping of the architectural representation of the application to a risk assessment;
selecting a service level based on the mapping; and
presenting a total cost of ownership based on the selected service level.

12. The non-transitory storage medium of claim 11, wherein the architectural representation includes a data flow architecture, a protocol flow architecture, and a security control flow architecture.

13. The non-transitory storage medium of claim 11, wherein the mapping aligns security policies to a standardized architecture.

14. The non-transitory storage medium of claim 11, further comprising defining multiple levels of security, wherein the selected service level includes some of the levels of security.

15. The non-transitory storage medium of claim 14, further comprising defining the multiple levels of security.

16. The non-transitory storage medium of claim 14, further comprising presenting multiple shared responsibility models.

17. The non-transitory storage medium of claim 11, wherein the selected service level defines expectations for a customer and a vendor of the application.

18. The non-transitory storage medium of claim 11, wherein the total cost of ownership includes a cost of operations and a cost of hardware and a capital cost.

19. The non-transitory storage medium of claim 18, wherein the total cost of ownership includes a human resources cost and an operating cost.

20. The non-transitory storage medium of claim 18, wherein at least a portion of the total cost is based on previous experience, which includes crowdsourced data.
